(19) United States
(12) Patent Application Publication
(10) Pub. No.: US 2010/0018377 A1
(43) Pub. Date: Jan. 28, 2010

(54) Universal 3-TAB center for a cutting disc

(76) Inventor: Kevin Baron, Oxnard, CA (US)

Correspondence Address: SANDRA LEE LIPKIN A LAW CORPORATION, P.O.Box 3518, VENTURA, CA, 93006, US

(21) Appl. No.: 12/454,149

(22) Filed: May 12, 2009

Related U.S. Application Data
(60) Provisional application No. 61/135,873, filed on Jul. 22, 2008.

(51) Int. Cl. B23D 61/02

(52) U.S. Cl. 83/835; 83/698.51; 83/663

(57) ABSTRACT

A cutting disc core for a circular shaped saw blade which has a circular shaped body which has a center hole and a circular peripheral edge upon which is to be mounted a plurality of spaced apart cutting segments that is to perform the cutting of the saw blade. Surrounding the center hole and formed within the body is a first plurality of slits with there being a solid tab that is integrally connected to the body located between each directly adjacent pair of slits defining a second diameter larger than the center hole. Also included is a second plurality of slits with there being a solid tab that is integrally connected to the body located between each directly adjacent pair of slits defining a third diameter larger than both the center hole and the second diameter defined by the first plurality of slits.

### REFERENCE TO PRIOR APPLICATION

This application claims the priority of provisional application 61/135,873, filed Jul. 22, 2008 entitled UNIVERSAL 3-TAB by Kevin Baron.

### BACKGROUND OF THE INVENTION

1. Field of the Invention

The field of this invention relates to a cutting disc core that is to be utilized in forming of a rotary cutting blade with the core being constructed to have a variable size center hole which is used in mounting of the cutting blade on different diameters of arbors of cutting machines.

2. Description of the Prior Art

In order to manufacture a circular saw blade, there is utilized a thin, metallic, disc shaped core with the cutting surface to be located on the periphery of the core. The core includes a center hole which is used to mount the saw blade to a motor operated device (saw machine) which will cause rotation of the blade. It is intended that the blade be rotated at a high speed when in contact with the structure that is being cut, which is generally cement, marble, stone, asphalt or other hard substance.

The most common type of arbor mounting hole, used on a circular blade saw, is a round hole that is located in the geometric center of the circular saw blade. Such arbor mounting holes pass over round cutting machine arbors that have a diameter close to that of the arbor mounting hole. In such round arbor mounting hole blades, any blade that has a round arbor mounting hole of the proper diameter can be mounted on the cutting machine.

Not all arbors have the same diameter. In such a case, different saw blades are typically required for different arbor diameters.

A need therefore exists for a new circular saw blade, having an arbor mount that can be attached to different arbor radii. This will enable a manufacturer or contractor to purchase one set of blades that can be used on a variety of different cutting machines having a variety of arbor diameters.

The instant inventor has provided in U.S. Pat. No. 6,796,210 for the ability to use one cutting blade for two different diameter arbors. Further, European Pat. No. EP1726393 has tried to solve this problem by providing the ability to knock out up to three different diamaters. However, the European patent includes a saw blade of a given diameter that has glued on either side two other discs. Each of the two discs have diamaters that are smaller than the saw blade itself and include the ability to punch out the center to change the diameter. However, this invention requires the use of three discs: the central bore and then one attached to either side of the central bore. Each of the attached discs have punch out-able diameters that different with the diameter of the central bore.

It is the primary object of the instant invention to simplify the process of providing more than two different diameter sizes in a given saw blade.

### SUMMARY OF THE INVENTION

The preferred embodiment of the present invention teaches a cutting disc core for a circular saw blade having a circular shaped body having a center hole and a continuous peripheral edge. The peripheral edge is adapted to have cutting segments mounted thereon. A first plurality of slits are formed within the body located directly adjacent the hole. These slits define a generally first circular configuration surrounding the hole and are located directly adjacent the hole. The slits, in essence, form a first circular ring which is integrally connected to the body by a plurality of solid tabs. The circular ring can be physically removed from the body by breaking of these tabs thereby increasing the size of the center hole to permit the mounting of the body on a larger size arbor of a sawing machine. A second plurality of slits are also formed within the body located directly adjacent the first plurality of slits. The second plurality of slits creates the same ability to change the diameter as the first plurality of slits. The tabs created by the second plurality of slits are staggered relative to the tabs created by the first plurality of slits. This provides for more structural integrity of the core.

A further embodiment of the present invention is where the first embodiment is modified by each slit having ends which define a radially outward extension with there being a tab integrally formed with the body between an extension of one slit and an extension of an adjacent slit.

A further embodiment of the present invention is where the basic embodiment is modified by there being at least three in number of tabs.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 shows a front view of the cutting disc core constructed in accordance with the present invention.

FIG. 2 is a close-up view of the center hole formed within the cutting disc core of the present invention.

FIG. 3 is a view similar to FIG. 2 but of a first modified form of center hole.

FIG. 4 is taken along line 4-4 in FIG. 2.

FIG. 5 is taken along line 5-5 of FIG. 3

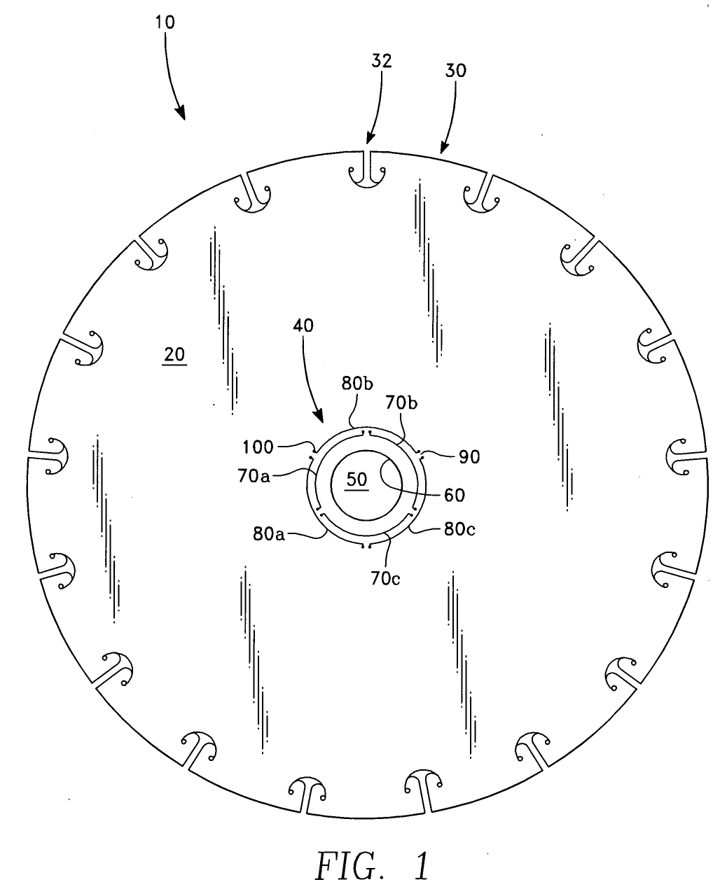

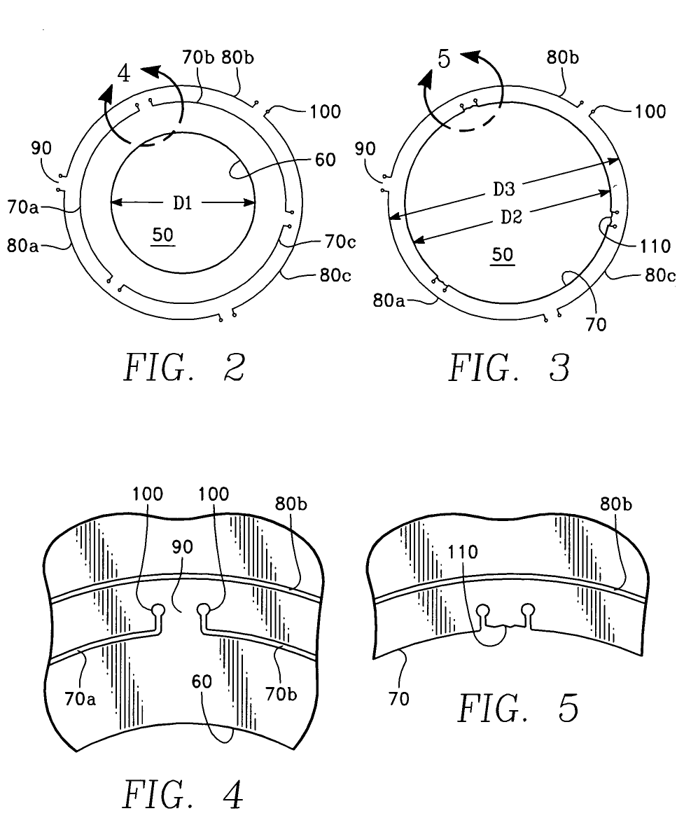

### DETAILED DESCRIPTION OF A PREFERRED EMBODIMENT

Turning to the drawings, the preferred embodiment is illustrated and described by reference characters that denote similar elements throughout the several views of the instant invention.

Referring particularly to the drawings, there is shown the cutting disc core 10 of this invention. The cutting disc core 10 takes the form of a circular shaped body which has an inner center hole 50 defined by the perimeter designated by the numeral 60 and defining a first diameter D1. The inner center hole 50 is to be used to mount the core 10 onto a sawing machine to affect the rotation of the core 10. The sawing machine is not shown and is deemed to be conventional. The core 10 has a peripheral edge 30. Formed within the peripheral edge 30 is a plurality of radial slots 32. Seventeen in number of the slots 32 are shown. However, the number of the slots 32 can be increased or decreased depending on the diameter of the core 10. The use of the radial slots 32 is deemed to be conventional and forms no specific part of this invention.

The portion of the peripheral edge 30 located between each directly adjacent pair of radial slots 32 is to define an area to which is to be laser welded a cutting segment (not shown). The mounting of the cutting segments on the core 10 is what produces the cutting blade. Surrounding the inner center hole 50 is a series of slits 70a, 70b, 70c that take a generally circular form that taken together form a second circle, defined by a diameter D2. Each of the slits 70a, 70b, 70c is arcuate and basically comprise about one hundred twenty degrees of a circle. Each of the slits 70a, 70b, 70c is to be formed from some type of cutting device, such as a laser. The slits 70a, 70b, 70c are to be formed entirely through the body 20 of the core 10.

Surrounding the first set of slits 70a, 70b, 70c is a second series of slits 80a, 80b, 80c that take a generally circular form that taken together form a third circle, defined by a diameter D3. Each of the slits 80a, 80b, 80c is arcuate and basically comprise about one hundred twenty degrees of a circle. As with the first plurality of slits 70a, 70b, 70c, the second plurality of slits 80a, 80b 80c is to be formed from some type of cutting device, such as a laser and is to be formed entirely through the body 20 of the core 10. The second plurality of slits creates the same ability to change the diameter as the first plurality of slits. The tabs created by the second plurality of slits are staggered relative to the tabs created by the first plurality of slits. This provides for more structural integrity of the core.

At each end of each slit 70a, 70b, 70c, 80a, 80b, 80c, there is formed a radially outward extension 100. Therefore, it is understood that there are two in number of the extensions 100 for each slit 70a, 70b, 70c, 80a, 80b, 80c. Separating the radially outward extensions 100 of each slit and the radially outward extension 100 of a partnering slit is a tab 90. It is to be understood that there is a similar such tab 90 located between the radially outward extensions 100 of each slit 70a, 70b, 70c, 80a, 80b, 80c. Therefore, there are three in number of the tabs 90 for each diameter.

In use, the space between D1 and D2 or the space between D2 and D3 can be knocked out using the tabs 90 created by the slits 70a, 70b, 70c, 80a, 80b, 80c. Once a diameter is punched out (see FIGS. 3 and 5), a new diameter 70 is created and the space connecting each former slit to the new perimeter of the new diameter and is designated 110, thereby providing for a continuous circular hole without any gaps.

The discussion included in this patent is intended to serve as a basic description. The reader should be aware that the specific discussion may not explicitly describe all embodiments possible and alternatives that are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. A cutting disc core for a circular saw blade comprising:
a circular shaped body having a center hole of a certain size and a continuous peripheral edge, said peripheral edge adapted to having cutting segments mounted thereon;
a first plurality of slits formed within said body located directly adjacent said center hole, said slits defining generally a first circular configuration surrounding said center hole and located directly adjacent said center hole, said slits form a circular ring integrally connected to said body by a plurality of solid tabs, whereby said circular ring can be physically removed from said body by breaking of said tabs thereby increasing the certain size of said center hole to permit mounting of said body on a larger sized arbor of a sawing machine; and each said tab having a radially outward portion, whereby breaking of each said tab to occur at said radially outward portion;
a second plurality of slits formed within said body located directly adjacent said center hole, said slits defining generally a second circular configuration surrounding said center hole and located directly adjacent said center hole, said slits form a circular ring integrally connected to said body by a plurality of solid tabs, whereby said circular ring can be physically removed from said body by breaking of said tabs thereby increasing the certain size of said center hole to permit mounting of said body on a larger sized arbor of a sawing machine; and each said tab having a radially outward portion, whereby breaking of each said tab to occur at said radially outward portion.
